(19) United States
(12) Patent Application Publication
(10) Pub. No.: US 2015/0086427 A1
(43) Pub. Date: Mar. 26, 2015

(54) LINE BREAK INDICATOR (WIRE IN AMMONIA LINES)

(71) Applicants: Jeffrey R. Kelso, Fort Wayne, IN (US); Jason B. Arriaga, Wheaton, IL (US); Adam C. Lack, Willow Springs, NY (US); Navtej Singh, Lombard, IL (US)

(72) Inventors: Jeffrey R. Kelso, Fort Wayne, IN (US); Jason B. Arriaga, Wheaton, IL (US); Adam C. Lack, Willow Springs, NY (US); Navtej Singh, Lombard, IL (US)

(73) Assignee: International Engine Intellectual Property Company LLC, Lisle, IL (US)

(21) Appl. No.: 14/395,916

(22) PCT Filed: Apr. 26, 2012
(86) PCT No.: PCT/US12/35123

§ 371 Date: Oct. 21, 2014

(51) Int. Cl. B01D 53/79; B01D 53/92; G01M 3/18; B01D 53/56

(52) U.S. Cl. CPC B01D 53/79; B01D 53/56; B01D 53/92; G01M 3/182; B01D 2251/2062; B01D 2257/404; B01D 2258/01
USPC 422/119; 422/168; 73/40.5 R

(57) ABSTRACT

Reductant delivery system having at least one canister containing reductant coupled, via delivery line, to after-treatment system having ammonia injector, is disclosed. Reductant includes ammonia adsorbing/desorbing material. Delivery line is connected at one end to ammonia injector and at another end detachably coupled by coupler to the canister. Controller may be used for metering flow of ammonia through delivery line to injector. Line-break detector detects disconnection within the delivery line to prevent loss of ammonia. Line-break indicator coupled to line-break detector is used, wherein the indicator activates upon the detector detecting a disconnection in the delivery line. Related methods for detecting and indicating a line break are disclosed.

### TECHNICAL FIELD

The present device and methods relate to connection and ammonia feed status indicators for an ammonia delivery system. More specifically, the device and methods relate to detection of an ammonia feed line break and indication of the same to prevent excessive ammonia loss.

### BACKGROUND

Compression ignition engines provide advantages in fuel economy, but produce both NOₓ and particulates during normal operation. New and existing regulations continually challenge manufacturers to achieve good fuel economy and reduce the particulates and NOₓ emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes is being employed in a growing number of systems.

One such system is the direct addition of ammonia gas to the exhaust stream. It is an advantage to deliver ammonia directly in the form of a gas, both for simplicity of the flow control system and for efficient mixing of the reducing agent, ammonia, with the exhaust gas. The direct use of ammonia also eliminates potential difficulties related to blocking of the dosing system, which difficulties are typically caused by, e.g., precipitation or impurities in a liquid-based urea solution. In addition, an aqueous urea solution cannot be dosed at a low engine load since the temperature of the exhaust line would be too low for complete conversion of urea to ammonia (and CO₂).

Due to its caustic nature, transporting ammonia as a pressurized liquid can be hazardous if the container bursts as the result of an accident or if a valve or tube breaks. In the case of using a solid storage medium, the safety issues are much less critical since a small amount of heat is required to release the ammonia and the equilibrium pressure at room temperature can be—if a proper solid material is chosen—well below 1 bar. Solid ammonia can be provided in the form of disks or balls loaded into a cartridge or canister. The canisters are then loaded into a mantle or other storage device and secured to the vehicle for use. Appropriate heat is applied to the canisters, which then causes the ammonia-containing storage material to release ammonia gas from the canister into a feed line where it is metered into the exhaust system of a vehicle, for example.

However, as the ammonia leaves the canister, it is in gas form and presents a potential hazard if released through an improper canister connection or through a broken feed line. Even a small leak could be problematic if only for the loss of ammonia, which may deplete the source earlier than scheduled replacement.

Further, as alluded to above, eventually the ammonia in a canister is depleted and must be recharged or replaced. Unfortunately, there are no systems in place which are capable of indicating the fill-status of a canister. This shortcoming requires a plurality of canisters to be used in a vehicle system in order to provide a level of redundancy. Further, the canisters are typically changed on a regular basis, regardless of the fill-level, to avoid the possibility of ammonia depletion during engine operation. The result is sometimes the carrying of too much ammonia to provide the desired redundancy, and sometimes the removal and replacement of partially-filled ammonia canisters with full canisters to avoid depletion. Such conditions and procedures may increase the possibility of an accidental ammonia release.

Thus, the present system and methods provide an on-board indication of a proper connection between the ammonia canister and the ammonia feed line. The system and methods facilitate proper scheduling of removal and replacement of ammonia canisters as well as provide real-time ammonia loads for canisters. These and other problems are addressed and resolved by the disclosed systems and method of the present application.

### SUMMARY

Generally speaking, an ammonia delivery system includes at least one canister containing a supply of ammonia in solid form (powder or granular) coupled, via a delivery line, to an exhaust gas after-treatment system having an ammonia injector. The delivery line is connected at one end to the ammonia injector and at another end it is detachably coupled by a coupler to the at least one canister. A controller may be used for metering flow of ammonia through the delivery line to the injector.

In an embodiment of the disclosed ammonia delivery system, a line-break detector for detecting a disconnection, such as a break, within the delivery line is used. In an aspect of the invention, a line-break indicator coupled to the line-break detector may be used, wherein the indicator activates upon the detector detecting a disconnection in the delivery line.

In various embodiments of the system, the line-break indicator comprises an annunciator electronically connected to the line-break detector. The annunciator may emit a visual signal, such as a LED light or a reading from an analog or digital display, an audible signal, such as a click, beep, buzz, chime, etc., or both.

In a preferred embodiment of the system, the line-break detector comprises at least one wire extending a length of the delivery line, wherein a break in the wire activates an annunciator. The wire(s) may be positioned on an external surface of the delivery line, integrated into a sidewall of the delivery line, located within the delivery line, or some combination of these configurations. An electric signal being transmitted through the at least one wire terminates when the at least one wire experiences a break or disconnection.

In a method for determining a break in an ammonia feed line, an ammonia canister is positioned for connection to a coupler fixed to an ammonia feed line to allow feeding of ammonia from the canister through the feed line to an ammonia injector. An electronic signal is passed along a length of the feed line and a disruption in the signal may be detected to signify a line break.

It is a further aspect of the method to activate an annunciator upon detection of a disruption in the electronic signal. In an embodiment, at least one wire extending along a length of the feed line, either on an outer surface, an inner surface, within the sidewall, or some combination, is used for transmitting the electric signal. A break in the ammonia line results in a break in the at least one wire and, thus, a disruption in the electric signal.

In various embodiments, the annunciator may include initiating a visual signal, an audible signal, or both. A emergency stop may be triggered in the ammonia flow controller by the signal disruption as well.

### BRIEF DESCRIPTION OF THE DRAWINGS

FIG. 1 is a schematic overview of an ammonia storage and delivery system working in conjunction with a vehicle engine system, exhaust gas after-treatment system and the vehicle electronics;

FIG. 2 is a schematic illustrating an embodiment of the present on-board fill-status indicator system;

FIG. 3 is a schematic illustrating a partial cross-section of an ammonia canister and an embodiment of the present canister fill-status indicator system;

FIG. 4 illustrates a particular embodiment of the indicator system used in a three cartridge array;

FIG. 5 is a schematic illustrating an embodiment of a feed line coupler/canister connection status indicator;

FIG. 6 is a schematic illustrating an embodiment of a line-break detection and indicator system; and

FIGS. 7A-7D illustrate various embodiments of the placement of the line-break detection wire.

### DETAILED DESCRIPTION

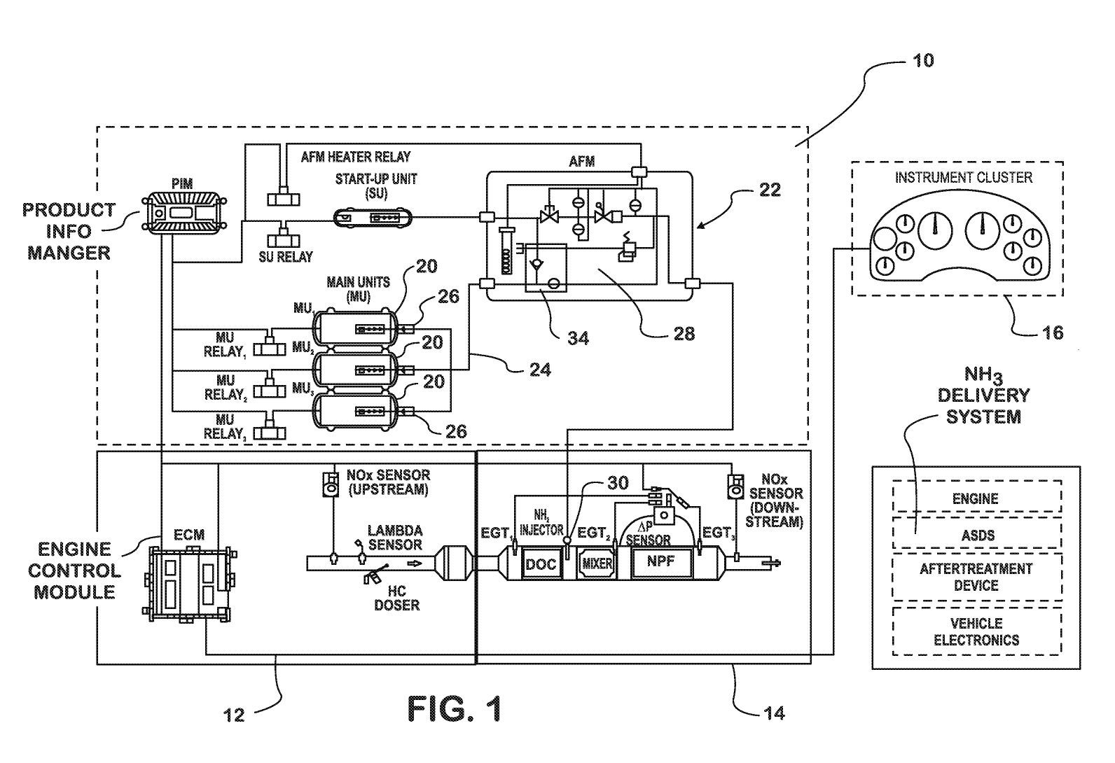

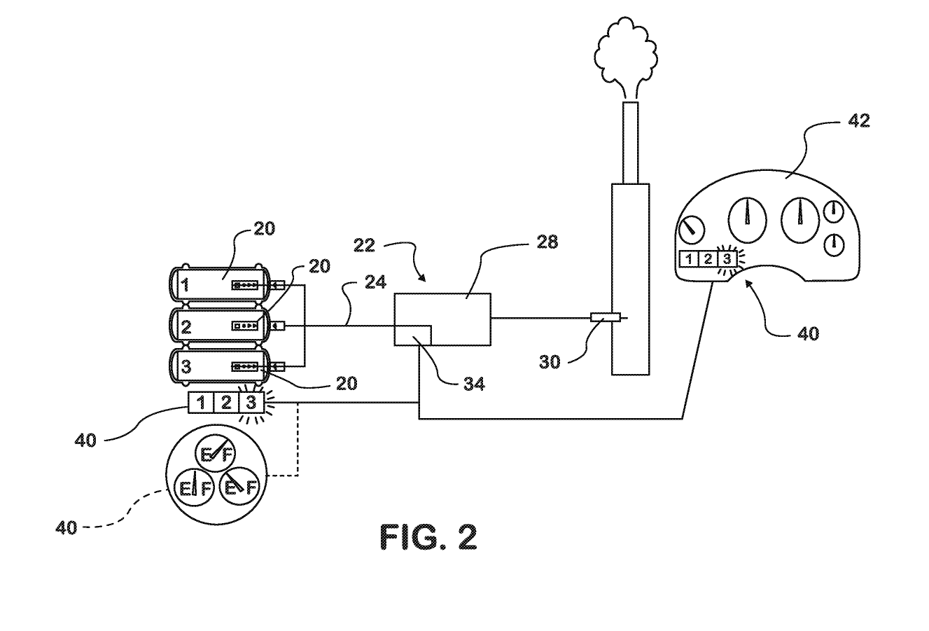

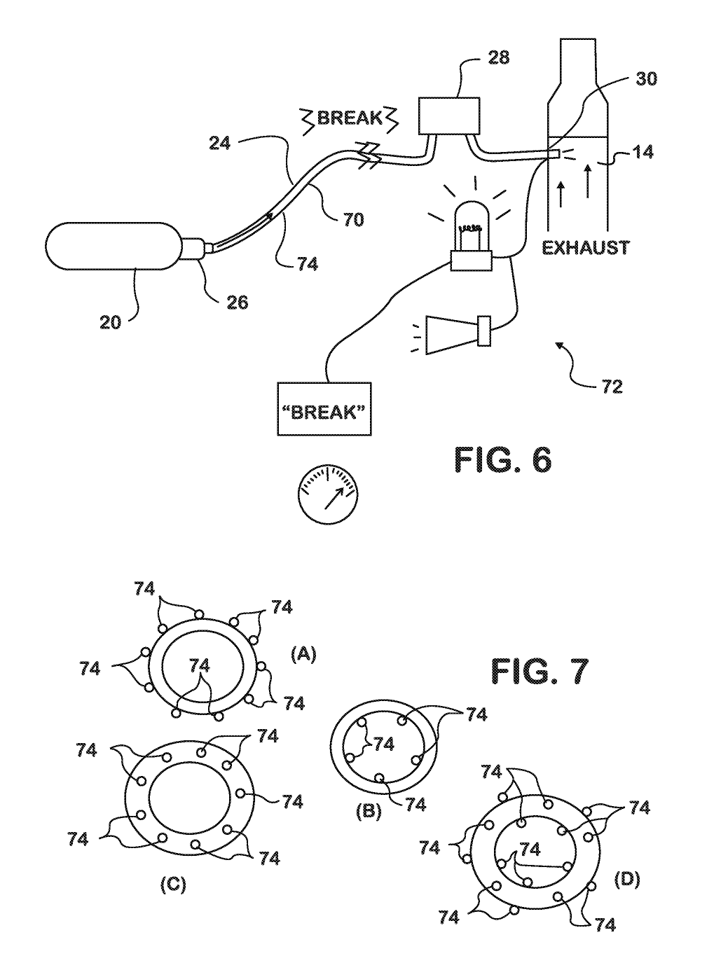

With reference to FIGS. 1-7, the embodiments of the system and methods are described to one of skill in the relevant art. Ammonia storage and dosing systems (ASDS), which are part of the exhaust gas NOₓ reduction (EGNR) system used in vehicles, may be comprised of several components, including a start-up canister, at least one main canister contained within a housing or storage compartment, wherein the canisters contain an ammonia adsorbing/desorbing material, an ammonia control module (AFM), a peripheral interface module (PIM), and possibly other components depending on vehicle specifications. Generally speaking, an ammonia delivery system, designated with the reference number 10 in the figures, typically works in conjunction with an internal combustion engine 12, the exhaust gas after-treatment system 14, and the vehicle electronics 16.

In an embodiment of the ammonia delivery system 10, at least one canister 20 containing a supply of ammonia in an ammonia adsorbing/desorbing material is loaded into a carrier and secured in place. The canister 20 is connected to a metering system 22 via special tubing 24 and a special connector 26 to prevent leakage of the ammonia. In most systems, a plurality of canisters will be used to provide greater travel distance between recharging. However, the current system works sufficiently with a single canister for some applications and as desired or necessary. A heating jacket (not shown) is typically used around the canister to bring the ammonia adsorbing/desorbing material to a sublimation temperature.

Suitable ammonia adsorbing/desorbing material useful in the treatment of NOₓ in an exhaust stream includes metal-ammine salts, which offer a solid storage medium for ammonia, and represent a safe, practical and compact option for storage and transportation of ammonia. Ammonia may be released or desorbed from the metal ammine salt by heating the salt to temperatures in the range from 10° C. to the melting point to the metal ammine salt complex, for example, to a temperature from 30° to 700° C., and preferably to a temperature of from 100° to 500° C. It has been found that the ammine salt is best having the general formula M(NH₃)ₙX_{z}, where M is one or more metal ions selected from the group consisting of Li, Mg, Ca, Sr, V, Cr, Mn, Fe, Co, Ni, Cu, and Zn, n is the coordination number in the range of from 2 to 12, and X is one or more anions, depending on the valence of M, selected from the group consisting of F, Cl, Br, I, SO₄, MoO₄, and PO₄. A saturated strontium chloride has been found to be preferable for the canister storage space. While embodiments using ammonia as the preferred reductant are disclosed, the invention is not limited to such embodiments, and other reductants may be utilized instead of, or in addition to, ammonia for carrying out the inventions disclosed and claimed herein. Examples of such other, or additional reductants include, but are not limited to, urea, ammonium carbamate, and hydrogen.

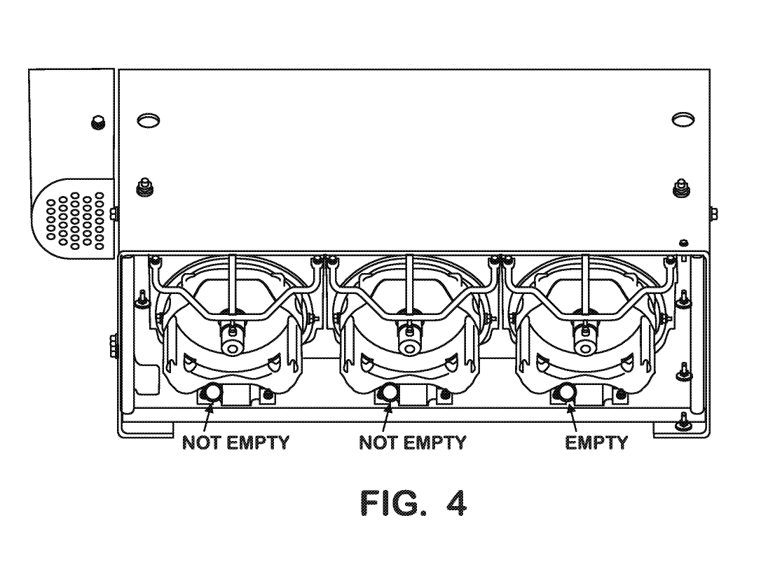

Once converted to a gas, the ammonia is metered at the ammonia flow module (AFM) 28 and is directed to an exhaust gas after-treatment system 14 having an ammonia injector 30, as shown in FIG. 1. The AFM 28 includes a controller 34 for metering flow of ammonia to an injector located within the after-treatment system 14. By “metering” it is meant that the controller 34 controls ammonia flow (rate and duration) and stores information about such details, possibly including for example: (1) the amount of ammonia required by the exhaust gas after-treatment system 14; (2) the amount of ammonia being delivered; (3) which of the multiple canisters provided ammonia; (4) the starting volume of deliverable ammonia in the canister; and (5) other such data which may be relevant to determining the amount of deliverable ammonia in each canister. The information may be monitored on a periodic or continuous basis. When the controller 34 determines that the amount of deliverable ammonia (i.e., approximately the amount of ammonia remaining in a particular canister) is below a predetermined level, a status indicator 40 electronically connected to the controller 34 is activated. The indicator 40 may be used to generally indicate a status of the canister 20, such as, for example, “Full” or “Empty” (see FIG. 4, for example) or it may be a type of analog or digital gauge used to indicate a specific amount of remaining deliverable ammonia.

In an embodiment for indicating a general threshold level of ammonia, the status indicator is preferably a single LED or other such simple visual indicator capable of signifying two separate conditions (e.g., LED “on”=empty and “off”=not empty). The predetermined threshold level may be “empty” or it may be, for example, when only 10% of deliverable ammonia remains in a canister. In a similar embodiment, the status indicator may include a series of LEDs (or other such visual indicators) to indicate ranges or a decreasing series of different threshold levels of deliverable ammonia remaining—e.g., one light=80%, two lights=50%, three lights=20%, etc. For more acute concerns, the status indicator may use an analog or digital display of remaining ammonia, much like a fuel gauge on a vehicle operates.

The visual indicator 40 may be mounted in proximity to the canister storage area to better advise those individuals charged with recharging and replacing empty canisters, and/or the indicator 40 may be mounted within the vehicle cab as part of the vehicle instrument cluster 42. When a first canister registers as “empty” or when it is removed from the canister mounting, the controller 34 automatically switches to a second supply of ammonia in a second canister.

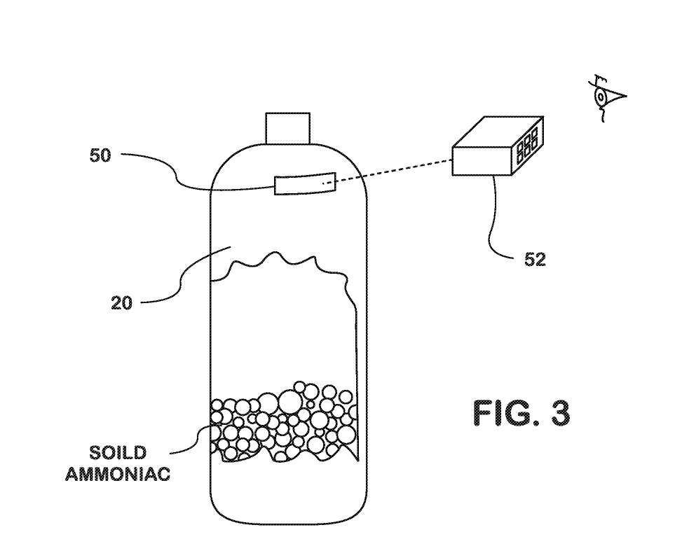

In another feature of an embodiment of the present system, a method for tracking the ammonia level in the ammonia canister 20 may be used on each canister, as illustrated in FIG. 3. That is, after a canister is removed from the vehicle's ammonia storage and delivery system, the remaining ammonia in the subject canister can be readily determined. Generally speaking, the method comprises attaching a memory storage device to each ammonia canister, determining the volume of ammonia in the canister, storing information relevant to the determined volume in the memory storage device and periodically updating the information on the memory storage device as the ammonia is used.

As with the system 10 previously described, the method further comprises metering the use of the ammonia after the step of storing the information. The system controller 34 previously described is suitable for such metering and information storage. However, the controller 34 remains with the vehicle when the ammonia canisters are removed and, therefore, cannot suitably operate to make such information available for a removed canister. Instead, the memory storage device 50 affixed to the ammonia canister comprises an RFID tag 50 which can be read by a conventional RFID reader 52.

When a canister 20 is connected to the vehicle's ammonia storage and delivery system 10, an RFID reader/writer in the metering system 22 can frequently update the information stored on the RFID tag 50 as ammonia is depleted. As the controller 34 determines information about each coupled canister 20, the RFID reader/writer can easily write such information to the individual RFID tag 50 on each canister. Periodically or continuously updating the information merely comprises the steps of calculating the amount of ammonia remaining in the canister based on the flow rate and duration metered by the controller 34 and then storing a value relevant to the calculated amount on the memory storage device, i.e., the RFID tag 50.

In an embodiment of the canister ammonia volume tracking method, each ammonia canister 20 comprises a memory storage device (e.g., RFID tag) 50 affixed to the canister 20, wherein the memory storage device contains information relevant to the volume of ammonia stored in the canister at a given time. The vehicle components include a metering device for tracking the amount of ammonia delivered from the canister over a period of time, and an input device (e.g., RFID reader/writer) for periodically updating the memory storage device based on the amount of ammonia delivered from the canister 20 as tracked by the metering device 22.

Before the canister 20 is removed from the vehicle, the memory storage device 50 is updated with current ammonia load information. Then, a conventional handheld RFID reader 52 may be used at canister drop-off locations to determine the fill-status of each canister 20.

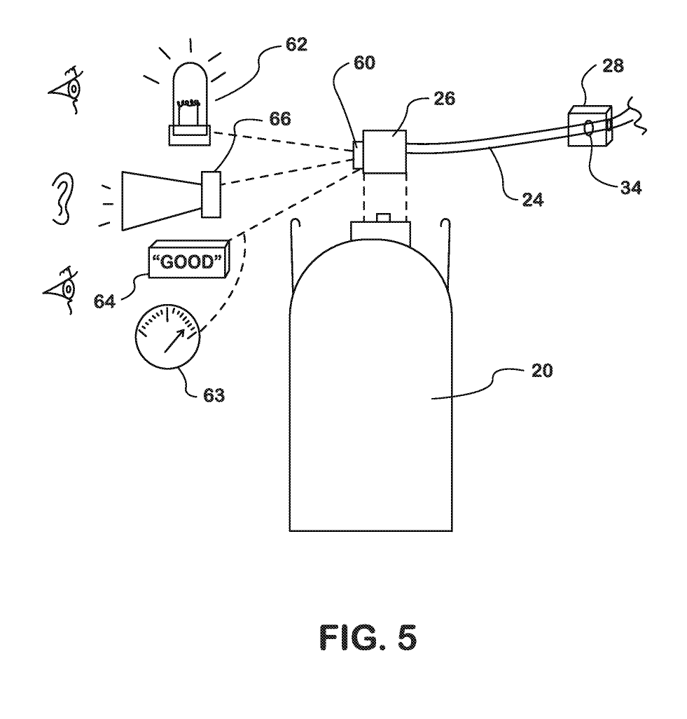

Referring to FIGS. 5-7, another aspect of the present system can be more readily understood. There are two additional points for potential ammonia leaks in the present system. The first is as a result of an improper coupling at any point in the ammonia flow, while the second is as a result of a break in the feed line.

As to leaks due to improper couplings, an embodiment of the system includes a positive connection indicator 60 which signals when a proper connection is achieved between the ammonia supply and the feed/delivery line 24. At least one canister 20 containing a supply of ammonia in an ammonia adsorbing/desorbing material is connected, via a coupler 26 attached to an end of an ammonia delivery line 24, to an exhaust gas after-treatment system 14 having an ammonia injector 30. As previously described, an AFM 28 having a controller 34 is used for metering flow of the ammonia through the delivery line 24 to the injector 30. The connection status indicator 60 is used to provide a connection status of the coupler 26 to the canister 20 or a manifold (not shown) where multiple canisters are in use.

In an embodiment of the ammonia delivery system 10, the status indicator 60 may provide a visual signal 62, an audible signal 66, or both when a proper connection is made. A preferred indicator is an LED or a series of LEDs. Alternatively, the visual signal 62 may be provided by an analog display/gauge 63 or a digital display 64. The audible signal 66 may be provided by an electronic annunciator using any variety or combination of sounds, including a click, beep, buzzer, etc. The status indicator 60 can be used to indicate either proper or improper connection or disconnection of the coupler 26 to the canister 20.

In use, the user is able to verify a proper connection between an ammonia canister 20 and a coupler attached to a feed line 24 for a delivery system 10. First, at least one ammonia canister 20 must be positioned for connection to a coupler 26 fixed to an ammonia feed line 24. Then, a mechanism such as the status indicator 60 must be set to activate upon a proper connection between the ammonia canister 20 and the coupler 26. When the user connects the coupler 26 to the ammonia canister 20, the user is able to determine whether the mechanism has been activated and, therefore, whether a proper connection has been made.

Where an activation of the status indicator 60 is not made—i.e., the connection is not proper—then the user may disconnect the coupler 26 from the ammonia canister 20 and then reconnect the coupler 26 to the ammonia canister 20. This disconnect/reconnect pattern can be followed until the user has determined that that the status indicator 60 has been activated.

The other potential for an ammonia gas leak is as a result of a break or disconnection of some kind in the ammonia delivery line 24. Accordingly, a feature of another embodiment of the ammonia delivery system 10 is the use of a line-break detector 70 and indicator 72. The line-break indicator 72 is connected and responsive to the detector 70 and is useful for visually and/or audibly indicating a disconnection or break at any point in the ammonia delivery line 24.

As with the connection indicator 60 described above, a preferred mechanism for use with the line-break indicator 72 is an electronic annunciator connected to the line break detector 70. The annunciator may be a LED, a series of LEDs, or some other electronic visual signal, such as a analog or digital gauge. The annunciator may also emit an audible signal such as a beep, buzz, click, chime or the like.

The preferred line-break detector 70 for the ammonia delivery system 10 comprises at least one wire 74 extending a length of the feed line 24, from the coupler 26 to the flow controller 28. The wire(s) 74 would have an electric signal constantly running there through such that a break in any part of the wire 74 would prevent transmission of the signal. A break in the wire(s) 74 would coincide with a break in the physical ammonia feed line 24. The termination of the electric signal would trigger the activation of the line-break indicator 72.

The positioning of the line-break detector 70 is variable. As illustrated in FIGS. 7A-7D, the wire(s) 74 may be positioned on an external surface of the feed line 24 (7A), integrated into a sidewall of the feed line 24 (7B), located within an interior of the feed line 24 (7C), or a combination of these locations (7D).

As still a further safety feature of the present ammonia delivery system 10, the ammonia flow controller 28 may be signaled to automatically stop the ammonia flow from the canister 20 through the feed line 24 upon an event related to a line break, such as termination of the electric signal or activation of the line-break indicator 72.

What is claimed is:

1. An reductant delivery system comprising:
at least one canister containing a supply of reductant;
an exhaust gas after-treatment system having an injector;
a delivery line connected at one end to the injector and at another end detachably coupled by a coupler to the at least one canister;
a controller for metering flow of reductant through the delivery line to the injector; and
a line-break detector for detecting a disconnection within the delivery line.

2. The reductant delivery system of claim 1, wherein the reductant is ammonia.

3. The reductant delivery system of claim 1, further comprising a line-break indicator coupled to the line-break detector, wherein the indicator activates upon the detector detecting a disconnection in the delivery line.

4. The reductant delivery system of claim 3, wherein the line-break indicator comprises an annunciator electronically connected to the line-break detector.

5. The reductant delivery system of claim 4, wherein the annunciator emits a visual signal.

6. The reductant delivery system of claim 5, wherein the annunciator comprises an LED.

7. The reductant delivery system of claim 5, wherein the annunciator comprises a series of LEDs.

8. The reductant delivery system of claim 5, wherein the annunciator comprises an analog display.

9. The reductant delivery system of claim 5, wherein the annunciator comprises a digital display.

10. The reductant delivery system of claim 4, wherein the annunciator emits an audible signal.

11. The reductant delivery system of claim 1, wherein the line-break detector comprises at least one wire extending a length of the delivery line, wherein a break in the at least one wire activates an annunciator.

12. The reductant delivery system of claim 11, wherein the at least one wire is positioned on an external surface of the delivery line.

13. The reductant delivery system of claim 11, wherein the at least one wire is integrated into a sidewall of the delivery line.

14. The reductant delivery system of claim 11, wherein the at least one wire is located within the delivery line.

15. The reductant delivery system of claim 11, wherein an electric signal is transmitted through the at least one wire.

16. The reductant delivery system of claim 15, wherein the electric signal terminates when the at least one wire experiences a break.

17. A method for indicating a break in an ammonia feed line used in a vehicle exhaust after-treatment system, the method comprising the steps of:
positioning an ammonia canister for connection to a coupler fixed to an ammonia feed line;
feeding ammonia from the canister through the feed line to an ammonia injector;
sending an electronic signal along a length of the feed line; and
detecting a disruption in the electronic signal to signify a line break.

18. The method of claim 17, further comprising the step of activating an annunciator upon detection of a disruption in the electronic signal.

19. The method of claim 17, further comprising the steps of:
providing at least one wire along a length of the feed line; and
sending an electronic signal through the at least one wire, wherein a break in the ammonia line results in a break in the at least one wire.

20. The method of claim 18, wherein the step of activating an annunciator comprises the step of initiating a visual signal.

21. The method of claim 18, wherein the step of activating an annunciator comprises the step of initiating an audible signal.

22. The method of claim 19, wherein a break in the at least one wire activates the annunciator.

23. The method of claim 18, further comprising the step of automatically ending the ammonia feed from the canister through the feed line upon activation of the annunciator.

24. The method of claim 22, further comprising the step of automatically ending the ammonia feed from the canister through the feed line upon activation of the annunciator.
